(19) United States
(12) Patent Application Publication
(10) Pub. No.: US 2021/0014253 A1
(43) Pub. Date: Jan. 14, 2021

(54) DEVICE AND METHOD FOR INTRUSION DETECTION IN A COMMUNICATIONS NETWORK

(71) Applicant: Robert Bosch GmbH, Stuttgart (DE)

(72) Inventors: Andreas Weber, Weissach (DE); Janin Wolfinger, Stuttgart (DE); Jens Gramm, Tuebingen (DE); Michael Herrmann, Düsseldorf (DE)

(21) Appl. No.: 16/921,052

(22) Filed: Jul. 6, 2020

(30) Foreign Application Priority Data
Jul. 10, 2019 (DE) 102019210226.3

(51) Int. Cl. H04L 29/06

(52) U.S. Cl. CPC H04L 63/1425; H04L 63/1416; H04L 63/20; H04L 63/0236; H04L 63/1466

(57) ABSTRACT

A method and a device for anomaly detection, the device including at least one port and a processing unit. The at least one port is designed to process, in particular to send or to receive, a data packet. The processing unit is designed to check, as a function of a first piece of information concerning the physical port at which the data packet is processed, and as a function of a second piece of information from at least one protocol header of the data packet, whether or not the data packet to be processed, including this second piece of information, is allowed to be processed at this physical port. An anomaly is detected when it is determined that the data packet is not allowed to be processed at the physical port.

### CROSS REFERENCE

The present application claims the benefit under 35 U.S.C. § 119 of German Patent Application DE 102019210226.3 filed on Jul. 10, 2019, which is expressly incorporated herein by reference in its entirety.

### FIELD

The present invention is directed to a method and a device for recognizing an intrusion in a communications network.

### BACKGROUND INFORMATION

For intrusion detection, “Network Intrusion Detection and Prevention systems” (NIDPSs) are used, whose task is to identify and respond to anomalies in the network traffic of a distributed computer system. NIDPSs are systems that are typically used to detect and prevent intrusions of corporate networks, so-called enterprise networks. NIDPSs may also be used in automotive networks. Automotive networks are internal networks of vehicles, with “Electronic Control Units” (ECUs) as network nodes.

Due to functional differences between enterprise networks and automotive networks, NIDPSs for enterprise networks cannot be efficiently used for automotive networks.

It is therefore desirable to provide an NIDPS for an automotive network.

### SUMMARY

In accordance with the present invention, an NIDPS is provided for an automotive network, differences between automotive networks and enterprise networks being taken into account. These are, for example, the network structure, the network dynamics, and the network nodes of the networks.

Network Structure:

An enterprise network typically follows a client server model in which there are a fairly small number of dedicated server network nodes that provide services to a typically larger number of client network nodes. Automotive networks are made up of ECUs, on which server applications as well as client applications are carried out.

Enterprise networks are generally much larger and more complex than automotive networks. The entirety of an enterprise network is typically much more segmented, being physically or logically separated into various zones and subnetworks. ECUs in typical automotive networks are separated, if at all, by so-called “gateways” into only a very small number of subnetworks, or are logically separated at the Ethernet level via so-called “Virtual Local Area Networks” (VLANs).

Network Dynamics:

Enterprise networks and automotive networks differ in the dynamics with which the network is changed and operated.

Network nodes may be arbitrarily exchanged in enterprise networks. For changes in server network nodes, it is typically still possible to make an adaptation in the configuration of the defense systems such as the NIDPS. In contrast, such adaptations for network nodes that are clients are not possible. This is due to the fact that clients connect to the network from changing locations, and are frequently replaced. In addition, it cannot be accurately predicted which applications are carried out on a client.

ECUs in automotive networks are exchanged very rarely, if at all, and then are often replaced only by an identical copy. It is therefore very unlikely that there is any change in the functional performance of the network. The network nodes are well known in an automotive network. Likewise, the server and client applications that run on the automotive network are well-defined, and details concerning the network communication may be predefined.

In enterprise networks, nodes from outside connections may be incorporated into a corporate network. In an automotive network, all communication nodes of the network are part of the internal vehicle network.

In enterprise networks it is typically possible for various users to use the same client. In ECUs of automotive networks there are no users, only server and client applications that perform their service.

Network Node:

With regard to the resources, the network nodes of an enterprise network are generally much more resource-intensive with regard to memory and performance, for example, than ECUs of an automotive network.

With regard to the software, in enterprise networks the network nodes are usually equipped with widely used standard operating systems and standard software, for which security vulnerabilities are known. For this reason, NIDPS systems in enterprise networks are focused on signature-based detection when an attempt is made to exploit known security vulnerabilities. The network nodes in automotive networks are often equipped with less widely used software. A majority of the signatures from NIDPS systems for enterprise networks are not applicable, and there are no fairly large databases concerning vulnerabilities that are known specifically for automotive networks.

The basic task of an NIDPS, i.e., detection and response to anomalies in the network traffic, is the same for enterprise networks and automotive networks. It is apparent from the above discussion that the basic operating principle of an efficient NIDPS for automotive networks should be fundamentally different from that of an NIDPS for enterprise networks. An NIDPS for an automotive network must make use of the known, static network structure as well as the considerably lower dynamics of the network users to be able to efficiently detect anomalies with limited resources.

In accordance with an example embodiment of the present invention, a method for anomaly detection in a communications network of a vehicle provides that as a function of a first piece of information concerning a physical port at which a data packet is processed, and as a function of a second piece of information from at least one protocol header of the data packet, a check is made whether or not the data packet to be processed, including this second piece of information, is allowed to be processed at this physical port, an anomaly being detected when it is determined that the data packet is not allowed to be processed at the physical port. The network traffic at the existing hardware ports, i.e., the switch ports, is analyzed in an “automotive Ethernet” switch. Anomalies that are caused by an intruder in the network are thus identified. The anomaly detection is based on protocol data fields of network packets. The anomaly detection is based on a linkage of virtual information from the at least one protocol header and physical information concerning the physical port, on which switch port these network packets are sent and received. This form of anomaly detection is particularly effective in particular in a static communications network of a vehicle.

The second piece of information is preferably determined from at least one protocol data field of at least one data packet. The content of protocol data fields is modifiable by an intruder. In contrast, the static communications network of the vehicle is additionally protected from intrusions due to the installation in the vehicle. It is thus difficult to alter physical ports. The evaluation of the protocol data fields allows reliable detection of an intrusion by a comparison with these protocol data fields.

In one aspect of the present invention, physical information concerning the physical port at which this data packet is received is determined as the first piece of information, it being checked whether or not the data packet including this second piece of information is allowed to be received at this physical port. This increases the flexibility of the anomaly detection in the communications network, in particular for the case that multiple ports are present at which the receipt of certain data packets is allowed or prohibited.

In another aspect of the present invention, physical information concerning the physical port at which this data packet is to be sent is determined as the first piece of information, it being checked whether or not the data packet including this second piece of information is allowed to be sent at this physical port. This increases the flexibility of the anomaly detection in the communications network, in particular for the case that multiple ports are present at which the sending of certain data packets is allowed or prohibited.

It is preferably checked, as a function of at least one preferably static association that is provided in particular in a list or table, whether or not the data packet is allowed to be processed at the port, the association associating one or multiple allowed or prohibited contents of the second piece of information with a physical port or multiple physical ports. The in particular static association allows a rapid comparison of allowed or not allowed processing based on the content of at least one protocol data field.

The second piece of information preferably includes a linkage that links multiple protocol data fields, the association associating at least one linkage of at least two protocol data fields and at least one physical port with one another. The check based on the content of multiple protocol data fields allows further differentiations. For example, protocol data fields of different protocol layers may be linked according to the ISO/OSI model in order to specify allowable or unallowable data packets for certain physical ports. For example, protocol data fields of the same protocol layer may be linked according to the ISO/OSI model in order to define the sender and receiver, or a message type including information concerning the sender and/or receiver, for distinguishing between different allowed or not allowed combinations.

The second piece of information preferably includes an address, in particular address information from various protocol levels, of a sender or of a receiver of the data packet. This represents a piece of information that is particularly easy to check, via which falsified addresses are detectable in a particularly effective manner. The term “address” is to be understood here as an all-encompassing term for address information from various protocol levels, for example an IP address or MAC address.

In accordance with an example embodiment of the present invention, a device for anomaly detection includes at least one port and a processing unit, the at least one port being designed to process, in particular to send or to receive, a data packet, the processing unit being designed to check, as a function of a first piece of information concerning the physical port at which the data packet is processed, and as a function of a second piece of information from at least one protocol header of the data packet, whether or not the data packet to be processed, including this second piece of information, is allowed to be processed at this physical port, an anomaly being detected when it is determined that the data packet is not allowed to be processed at the physical port. This device may be used particularly effectively as a switch or terminal in an in particular static communications network of a vehicle.

The processing unit is preferably designed to determine the second piece of information from at least one protocol data field of at least one data packet. The processing unit checks the protocol data fields anyway to allow the processing of the data packet. In this check, the processing unit may thus check a data packet, to be processed, particularly efficiently in the anomaly detection.

In one aspect of the present invention, the processing unit is designed to determine, as the first piece of information, physical information concerning the physical port at which this data packet is received, and to check whether or not the data packet including this first piece of information is allowed to be received at this physical port. In a communications network that is for the most part static, the ports for receiving certain data packets are largely fixed. Taking this additional information into account further improves the anomaly detection.

In one other aspect of the present invention, the processing unit is designed to determine, as the first piece of information, physical information concerning the physical port at which this data packet is to be sent, it being checked whether or not the data packet including this second piece of information is allowed to be sent at this physical port. In a communications network that is for the most part static, the ports for sending certain data packets are largely fixed. Taking this additional information into account further improves the anomaly detection.

The processing unit is preferably designed to check, as a function of at least one preferably static association that is provided in particular in a list or table, whether or not the data packet is allowed to be processed at the port, the association associating one or multiple allowed or prohibited contents of the second piece of information with a physical port or multiple physical ports. The association is established for the communications network by the vehicle manufacturer, for example. The use of this information additionally improves the anomaly detection.

The processing unit is preferably designed to determine the second piece of information as a linkage of multiple protocol data fields of the data packet, the association associating at least one linkage of at least two protocol data fields and at least one physical port with one another. The linkage allows further advantageous differentiations for the anomaly detection.

The processing unit is preferably designed to process the second piece of information, which includes an address of a sender or of a receiver of the data packet. This represents information that is specifiable by the manufacturer of the vehicle and checkable in the anomaly detection in a particularly effective manner.

Further advantageous specific embodiments result from the following description and the figures.

### BRIEF DESCRIPTION OF THE DRAWINGS

FIG. 1 shows a schematic illustration of a device for intrusion detection in accordance with the present invention.

FIG. 2 shows a schematic illustration of a data packet.

FIG. 3 shows steps in an example method for intrusion detection in accordance with the present invention.

### DETAILED DESCRIPTION OF EXAMPLE EMBODIMENTS

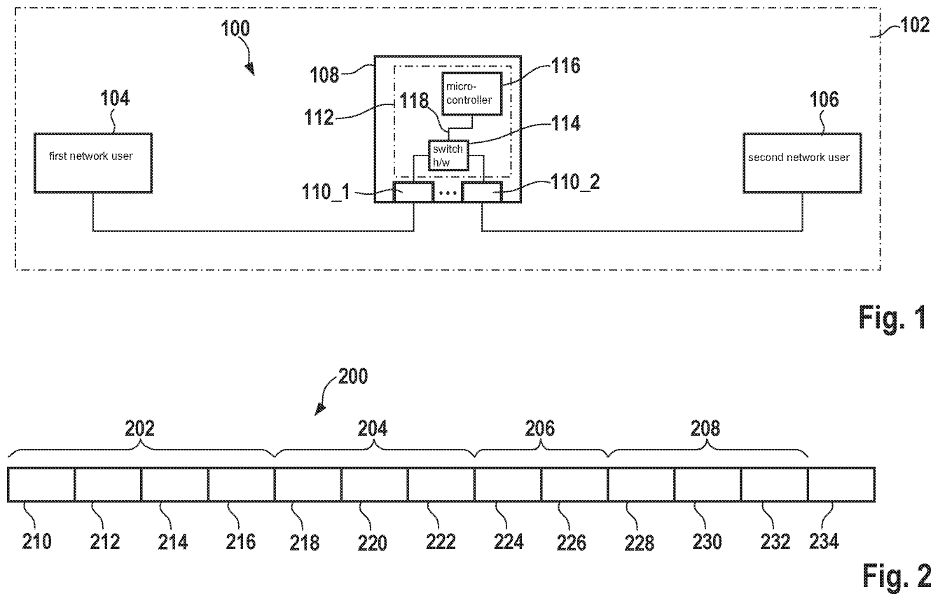

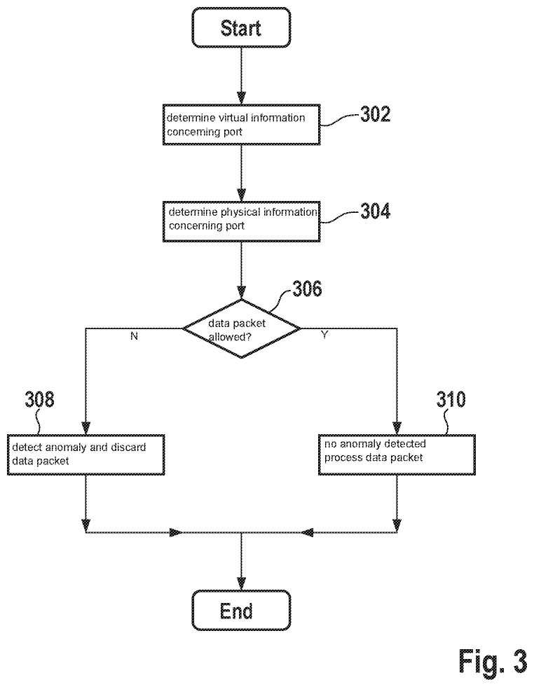

FIG. 1 schematically represents a communications network 100 in a vehicle 102. Communications network 100 includes a first network user 104, a second network user 106, and a connecting element 108. Connecting element 108 is, for example, a switch, in particular an automotive Ethernet switch. Connecting element 108 includes a plurality of ports, of which a first port 110-1 and a second port 110-2 are schematically illustrated. FIG. 1 schematically illustrates two ports; more or fewer ports 110 may also be provided. The ports in the example are hardware ports, also referred to as hardware switch ports. In the example, the communication in communications network 100 takes place according to automotive Ethernet. Ethernet technology, for example according to 100BASE-T1 Version 1.0, 1000BASE-T1, or 100BASE-TX, is thus referred to.

Connecting element 108 is designed to process incoming data packets at one of the ports. These data packets or copies of same may be output or discarded at this port or some other port.

Connecting element 108 includes a processing unit 112 that is designed to process the data packets. Processing device 112 may be implemented as part of switch hardware 114. Processing device 112 may be situated in a distributed manner, in particular on a portion of switch hardware 114 and a microcontroller 116 that is connected or connectable to this portion of switch hardware 114 via a data line 118.

Intrusion detection in communications network 100 for vehicle 102 is described below, via which anomalies in the data traffic may be detected on a device with an automotive Ethernet connection. The detection of anomalies in the data traffic is implemented with the aid of a “Network-based Intrusion Detection and Prevention System” (NIDPS). The device may be the automotive Ethernet switch or some other device which for each automotive Ethernet is connected to communications network 100 in vehicle 102.

FIG. 2 schematically illustrates a data packet 200 for the data traffic in communications network 100. Data packet 200 includes a plurality of protocol headers. Examples of protocols are Internet Protocol (IP), Scalable service-Oriented MiddlewarE over IP (SOME/IP), and User Datagram Protocol (UDP). The approach is likewise usable on other protocols, for example Transmission Control Protocol (TCP), Data Distribution Service (DDS), Diagnostics over Internet Protocol (DoIP), or Audio Video Bridging (AVB).

In the example, Version 4 of the IP protocol, i.e., IPv4, is used. Version 6, i.e., IPv6, may also be used.

In the example, data packet 200 includes a first protocol header 202, in particular an Ethernet header. In the example, data packet 200 includes a second protocol header 204, in particular an IPv4 header. In the example, data packet 200 includes a third protocol header 206, in particular a UDP header. In the example, data packet 200 includes a fourth protocol header 208, in particular a SOME/IP header.

A protocol header includes at least one protocol data field. In the example, first protocol header 202 includes four protocol data fields. In the example, the Ethernet header includes one each of a protocol data field for a sender MAC address 210, a receiver MAC address 212, a virtual local area network (VLAN), identification 214, and an Ethertype 216.

In the example, second protocol header 204 includes three protocol data fields. In the example, the IPv4 header includes one each of a protocol data field for an identification of protocol 218, a source IP address 220, and a destination IP address 222.

In the example, third protocol header 206 includes two protocol data fields. In the example, the UDP header includes one each of a protocol data field for an identification of source port 224, and an identification of destination port 226.

In the example, fourth protocol header 208 includes three protocol data fields. In the example, the SOME/IP header includes one each of a protocol data field for a service ID 228, a method ID 230, and a client ID 232.

Data packet 200 also includes payload 234.

The information from the protocol headers is referred to as virtual information. The information in the protocol headers in principle is arbitrarily selectable by a sender. Therefore, this information is modifiable for a possible intrusion.

In contrast, the information concerning at which port a data packet is received is a physical fact that may be established by the receiving device.

The basis of many network intrusions is falsifying virtual information in data packets, such as the MAC addresses or IP addresses. By falsifying his/her IP address, an intruder could appear, for example, as another network user and thus use certain services in a network that in fact are not allowed for the intruder. For automotive protocols such as SOME/IP, the falsification of data fields such as client ID or message ID is likewise possible in order to achieve intrusion targets such as unauthorized use of services.

One option for impeding such intrusions would be the use of cryptographic protocols for safeguarding communication channels, for example with the aid of Internet Protocol Security (IPsec) or Transport Layer Security (TLS). However, end nodes of a communication channel would have to support these protocols. These cryptographic protocols and the associated, necessary infrastructure increase the complexity of use in automotive networks.

In contrast, an intrusion may be reliably detected and optionally reported via the method described below. The method begins, for example, when a data packet 200 is received.

Virtual information from at least one protocol data field of at least one data packet 200 is determined in a step 302.

Physical information concerning a port at which this data packet 200 is processed is determined in a step 304.

For example, it is determined at which port data packet 200 has been received, or at which port data packet 200 is to be sent.

Steps 302 and 304 may also be carried out in the reverse order.

Data packet 200 is checked as a function of the virtual information and the physical information in a step 306. For a data packet 200 to be sent, it is checked whether or not data packet 200 including this virtual information is allowed to be sent at this physical port. For a received data packet 200, it is checked whether or not data packet 200 including this virtual information is allowed to be received at this physical port. For this purpose, for example a list or table of associations is checked, the association associating one or multiple allowed or prohibited contents of the virtual information with a physical port or multiple physical ports. For example, an address of a sender or receiver, such as the MAC address or IP address, is used as content of the virtual information that is associated by the association. A valid association, for example via a bit-by-bit comparison of the contents of the protocol header from data packet 200 with regard to their MAC address or IP address, with the MAC address or IP address provided by the association is then possible. A similar procedure may be followed for other contents such as Ethertype or service ID or client ID. Information concerning, for example, the number of the physical port at which data packet 200 is processed is already present in the checking device anyway. This information is likewise compared, for example, in a bit-by-bit comparison with the number of the port specified by the association.

The association may be designed as a blacklist or whitelist. It may be provided in particular that data packets 200 are discarded for which a combination of information, unknown from the association, concerning the physical port and virtual information is determined.

If it is determined that data packet 200 is not allowed to be processed at the port, a step 308 is carried out. Otherwise, a step 310 is carried out.

An anomaly is detected and data packet 200 is discarded in step 308. Optionally, a report may be sent to report the anomaly. It may be provided not to discard data packet 200, but instead to transfer it for further processing according to one of the protocols. The further processing may include relaying of the data packet. Two preferred, but not sole, response options are:

1) the data packet is discarded;

2) the report is sent.

The method subsequently ends.

No anomaly is detected in step 310, and data packet 200 is processed. In the example, data packet 200 is sent or transferred for further processing according to one of the protocols.

The method subsequently ends.

One example of such a linkage of the virtual information on a physical port is described based on first port 110-1 and second port 110-2. The NIDPS checks, for example, whether data packets 200 with a certain sender MAC address are received only by first port 110-1. In addition, based on the receiver MAC address the NIDPS may check that such data packets 200 are sent only at second port 110-2.

Another example of such a linkage of the virtual information on the physical port is described based on information concerning a sender or a receiver of the data packet made up of the virtual information. The NIDPS checks, for example, whether data packets 200 with a certain sender MAC address are sent only by first port 110-1. In addition, based on the receiver MAC address the NIDPS may check that such data packets 200 are received only at second port 110-2.

Via this method, an NIDPS makes use of the characteristic feature of automotive networks that automotive networks are very static and defined in advance. Therefore, the required information, for example which MAC address may be received or sent at which physical switch ports, may be provided by the automobile manufacturer within the scope of NIDPS system knowledge. This mechanism makes use of the fact that, although an intruder in the network may be able to falsify virtual information of data packets, he/she is not able to falsify physical information.

In one aspect, multiple protocol data fields are linked and these linkages are regarded as virtual information. This virtual information linked by the NIDPS may be checked by the NIDPS, in addition or as an alternative to the virtual information that is determined from an individual protocol data field. For example, it is checked whether the linkage is allowed to be received on a physical port, or to be sent at a physical port.

For example, it is checked, based on protocol data fields of the same protocol header of data packet 200, whether data packet 200 is allowed to be processed on the physical port. For example, it is checked, based on the source IP and the destination IP from the IPv4 header of data packet 200, whether data packet 200 is allowed to be processed at second port 110-2.

For example, it is checked, based on protocol data fields of various protocol headers of data packet 200, whether data packet 200 is allowed to be processed on the physical port. For example, it is checked, based on the source IP from the IPv4 header and the source port from the UDP header of data packet 200, whether data packet 200 is allowed to be processed at first port 110-1.

For example, it is checked, from a plurality of protocol data fields of various protocol headers of data packet 200, whether data packet 200 is allowed to be processed on the physical port. For example, it is checked, based on the source IP and the destination IP from the IPv4 header, the source port and the destination port from the UDP header, and the service ID and the client ID from the SOME/IP header of data packet 200, whether data packet 200 is allowed to be processed at first port 110-1.

For data packets 200 that are to be received at one of the ports and sent at another of the ports or at the same port, it may also be checked whether the port association is allowed. For example, it is checked, as a function of the virtual information, whether a data packet 200 that is received at first port 110-1 is allowed to be sent at second port 110-2.

For any given data packet, the NIDPS checks, based on the system knowledge, for example, the linkage of the virtual information of the data packet on the one hand, and of the physical information concerning at which physical port the data packet has been received and at which physical port the data packet is to be sent, on the other hand. If a discrepancy with the NIDPS system knowledge is determined in the check of a data packet, this is a serious anomaly that is very likely caused by a malicious intrusion.

What is claimed is:

1. A method for anomaly detection in a communications network of a vehicle, the method comprising the following steps:
as a function of a first piece of information concerning a physical port at which a data packet is processed, and as a function of a second piece of information from at least one protocol header of the data packet, checking whether or not the data packet to be processed, including the second piece of information, is allowed to be processed at the physical port; and
detecting an anomaly based on determining by the checking that the data packet is not allowed to be processed at the physical port.

2. The method as recited in claim 1, wherein the second piece of information is determined from at least one protocol data field of the data packet.

3. The method as recited in claim 1, wherein physical information concerning the physical port at which the data packet is received is determined as the first piece of information, and wherein the checking includes checking whether or not the data packet including the second piece of information is allowed to be received at the physical port.

4. The method as recited in claim 1, wherein physical information concerning the physical port at which the data packet is to be sent is determined as the first piece of information, and wherein the checking includes checking whether or not the data packet including the second piece of information is allowed to be sent at the physical port.

5. The method as recited in claim 1, wherein the checking including checking, as a function of at least one static association that is provided in a list or table, whether or not the data packet is allowed to be processed at the port, the association associating one or multiple allowed or prohibited contents of the second piece of information with a physical port or multiple physical ports.

6. The method as recited in claim 5, wherein the second piece of information includes a linkage that links multiple protocol data fields, the association associating at least one linkage of at least two protocol data fields and at least one physical port with one another.

7. The method as recited in claim 1, wherein the second piece of information includes an address information from a protocol level, of a sender or of a receiver of the data packet.

8. A device for anomaly detection, the device comprising:
at least one port; and
a processing unit, the at least one port being configured to process a data packet, the processing unit to check, as a function of a first piece of information concerning the physical port at which the data packet is processed, and as a function of a second piece of information from at least one protocol header of the data packet, whether or not the data packet to be processed, including the second piece of information, is allowed to be processed at this physical port, and wherein the processing unit detects an anomaly when it is determined that the data packet is not allowed to be processed at the physical port.

9. The device as recited in claim 8, wherein the processing unit is configured to determine the second piece of information from at least one protocol data field of the data packet.

10. The device as recited in claim 8, wherein the processing unit is configured to determine physical information concerning the physical port at which the data packet is received as the first piece of information, and to check whether or not the data packet including the second piece of information is allowed to be received at the physical port.

11. The device as recited in claim 8, wherein the processing unit is configured to determine, as the first piece of information, physical information concerning the physical port at which the data packet is to be sent, and to check whether or not the data packet including the second piece of information is allowed to be sent at the physical port.

12. The device as recited in claim 8, wherein the processing unit is configured to check, as a function of at least one preferably static association that is provided in a list or table, whether or not the data packet is allowed to be processed at the port, the association associating one or multiple allowed or prohibited contents of the second piece of information with a physical port or multiple physical ports.

13. The device as recited in claim 12, wherein the processing unit is configured to determine the second piece of information as a linkage of multiple protocol data fields of the data packet, the association associating at least one linkage of at least two protocol data fields and at least one physical port with one another.

14. The device as recited in claim 8, wherein the processing unit is configured to process the second piece of information, which includes an address of a sender or of a receiver of the data packet.

15. A non-transitory computer-readable memory medium on which is stored a computer program for anomaly detection in a communications network of a vehicle, the computer program, when executed by a computer, causing the computer to perform the following steps:
as a function of a first piece of information concerning a physical port at which a data packet is processed, and as a function of a second piece of information from at least one protocol header of the data packet, checking whether or not the data packet to be processed, including the second piece of information, is allowed to be processed at the physical port; and
detecting an anomaly based on determining by the checking that the data packet is not allowed to be processed at the physical port.
